(19) United States
(12) Patent Application Publication
(10) Pub. No.: US 2020/0087444 A1
(43) Pub. Date: Mar. 19, 2020

(54) EPOXY RESIN, PRODUCTION METHOD, AND EPOXY RESIN COMPOSITION AND CURED PRODUCT THEREOF

(71) Applicant: DIC Corporation, Tokyo (JP)

(72) Inventors: Kazuhisa Yamoto, Ichihara-shi (JP); Gensuke Akimoto, Ichihara-shi (JP); Nobuya Nakamura, Ichihara-shi (JP)

(21) Appl. No.: 16/495,482

(22) PCT Filed: Mar. 13, 2018
(86) PCT No.: PCT/JP2018/009660

§ 371 Date: Sep. 19, 2019

(30) Foreign Application Priority Data
Mar. 29, 2017 (JP) 2017-065049

(51) Int. Cl. C08G 59/24; C08L 63/04; C08G 59/50; C08G 59/62; C08G 59/40; C08G 59/42

(52) U.S. Cl. CPC C08G 59/245; C08L 63/04; C08G 59/5006; C08G 59/5033; C08G 59/621; C08J 5/24; C08G 59/4215; C08G 59/4223; C08L 2201/02; C08L 2201/08; C08L 2203/20; C08G 59/4021

(57) ABSTRACT

It is an issue to provide an epoxy resin that has excellent fluidity and curability, that provides a cured product with favorable moisture resistance and mechanical strength, and that is suitable for use in a semiconductor sealing material, a circuit board, and the like, to provide a method for producing the epoxy resin, and to provide an epoxy resin composition containing the epoxy resin and a cured product of the epoxy resin composition. Specifically, an epoxy resin that is epoxy resin (A) primarily containing epoxidized dihydroxybenzene in which an alkyl group having a carbon number of 1 to 8 may be included as a substituent on an aromatic ring, wherein the area ratio of the maximum peak in GPC measurement is 90% or more, a method for producing the epoxy resin, an epoxy resin composition containing the epoxy resin, and a cured product of the epoxy resin composition are provided.

### TECHNICAL FIELD

The present invention relates to an epoxy resin that has excellent fluidity and curability, that provides a cured product with favorable moisture resistance and mechanical strength, and that is suitable for use in a semiconductor sealing material, a circuit board, and the like, to a method for producing the epoxy resin, and to an epoxy resin composition containing the epoxy resin and a cured product of the epoxy resin composition.

### BACKGROUND ART

Curable resin compositions including epoxy resins and various curing agents are used for adhesives, forming materials, paints, photoresist materials, developing materials, and the like and, in addition, are widely used in the electric-electronic field, for example, in semiconductor sealing materials and printed circuit board insulating materials, from the viewpoint of excellent heat resistance, moisture resistance, and the like of the resulting cured product.

Regarding the semiconductor sealing materials, liquid sealing capable of thinly and locally resin-sealing semiconductor joints is frequently used instead of solid sealing used in the related art in accordance with the trend of size reduction and weight reduction of electronic equipment. Liquid epoxy resins used therefor are required to have excellent fluidity, curability, moisture resistance, adhesiveness, mechanical strength, and insulation reliability.

For example, an epoxy resin having an allyl group as a substituent on an aromatic ring with a bisphenol skeleton is provided as the epoxy resin that is suitable for use in the semiconductor sealing material (for example, refer to PTL 1).

Using the above-described epoxy resin as a base member of a curable resin composition enables a certain effect to be exerted on the fluidity of the composition and on the strength of the cured product compared with the case in which a common bisphenol-type epoxy resin is used. However, the balance between the fluidity, the curability, the low hygroscopicity, and the mechanical strength of the resin composition does not adequately satisfy the level required in recent years. Therefore, further improvements have been required.

### CITATION LIST

### Patent Literature

PTL 1: Japanese Unexamined Patent Application Publication No. 2015-000952

### SUMMARY OF INVENTION

### Technical Problem

Accordingly, an issue to be addressed by the present invention is to provide an epoxy resin that has excellent fluidity and curability, that provides a cured product with favorable moisture resistance and mechanical strength, and that is suitable for use in a semiconductor sealing material, a circuit board, and the like, to provide a method for producing the epoxy resin, and to provide an epoxy resin composition containing the epoxy resin and a cured product of the epoxy resin composition.

### Solution to Problem

To address the above-described issues, the present inventors performed intensive research. As a result, it was found that using an epoxy resin as one component of a curable composition, the epoxy resin primarily containing epoxidized dihydroxybenzene in which an alkyl group having a carbon number of 1 to 8 may be included as a substituent on an aromatic ring, where the area ratio of the maximum peak in GPC measurement was 90% or more, ensured an excellent balance between formability during heat curing, moisture resistance, and mechanical strength. Consequently, the present invention was realized.

That is, the present invention provides an epoxy resin that is an epoxy resin (A) primarily containing epoxidized dihydroxybenzene in which an alkyl group having a carbon number of 1 to 8 may be included as a substituent on an aromatic ring, wherein the area ratio of the maximum peak in GPC measurement is 90% or more, a method for producing the epoxy resin, and an epoxy resin composition containing the epoxy resin and a cured product of the epoxy resin composition.

### Advantageous Effects of Invention

According to the present invention, an epoxy resin that has excellent fluidity and curability, that provides a cured product with favorable moisture resistance and mechanical strength, and that is suitable for use in a semiconductor sealing material, a circuit board, and the like; a method for producing the epoxy resin; an epoxy resin composition containing the epoxy resin and a cured product of the epoxy resin composition; a semiconductor sealing material; a semiconductor device; a prepreg; a circuit board; a build-up film; a build-up substrate; a fiber-reinforced composite material; and a fiber-reinforced molded article can be provided.

### BRIEF DESCRIPTION OF DRAWINGS

FIG. 1 is a GPC chart of epoxy resin (A′-1) obtained in synthesis example 1.

FIG. 2 is a GPC chart of epoxy resin (A-1) obtained in example 1.

### DESCRIPTION OF EMBODIMENTS

<Epoxy Resin>

The present invention will be described below in detail.

The epoxy resin according to the present invention is epoxy resin (A) primarily containing epoxidized dihydroxybenzene in which an alkyl group having a carbon number of 1 to 8 may be included as a substituent on an aromatic ring, wherein the area ratio of the maximum peak in GPC measurement is 90% or more.

The dihydroxybenzene in which an alkyl group having a carbon number of 1 to 8 may be included as a substituent on an aromatic ring has 1 to 4 straight-chain or branched alkyl groups having a carbon number of 1 to 8 on an aromatic ring of catechol, resorcinol, or hydroquinone. Of these, it is preferable that an alkyl group be present on the aromatic ring of catechol because the resulting epoxy resin has low viscosity and the raw materials are readily available.

Examples of the epoxy resin include epoxy resins denoted by structural formula (1) below,

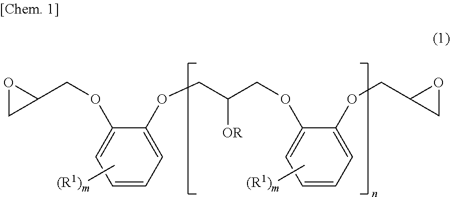

[in structural formula (1), R¹ represents a hydrogen atom or an alkyl group having a carbon number of 1 to 8, R represents a hydrogen atom or a glycidyl group, m represents 1 to 4, n represents the number of repetitions and has an average value of 0.01 to 5, and R, R¹, and m may be the same or different in each repetition].

Of the epoxy resins denoted by structural formula (1), R is preferably a hydrogen atom. From the viewpoint of availability of the raw materials and curability, R¹ is preferably a butyl group or an octyl group and particularly preferably a t-butyl group or a t-octyl group. Meanwhile, from the viewpoint of reactivity, in the case in which R¹ is an alkyl group, m is preferably 0 to 2 and particularly preferably 1. Further, n is more preferably within the range of 0.01 to 2, and particularly preferably the content of the epoxy resin in which n=0 is 70% by mass or more.

It is considered that including a branched alkyl group having a carbon number of 4 or 8 as a substituent on an aromatic ring appropriately adjusts the crosslinking density during the curing reaction because of the bulkiness thereof so as to ensure an excellent balance between the moisture resistance and the mechanical strength after heat curing and durability of these. In particular, when a cured product is obtained by using a curing agent described later, from the viewpoint of smooth proceeding of the curing reaction and from the viewpoint of readily adjusting the crosslinking density of a cured product to be within a more appropriate range, a t-butyl group is preferable, and the dihydroxybenzene is most preferably t-butylcatechol.

Regarding the epoxy resin according to the present invention, the area ratio of the maximum peak in the GPC measurement is 90% or more.

In the present invention, the GPC measurement is performed by the following method.

### <GPC Measurement Conditions>

Measurement apparatus: “HLC-8320 GPC” produced by Tosoh Corporation

Column: guard column “HXL-L” produced by Tosoh Corporation+“TSK-GEL G2000HXL” produced by Tosoh Corporation+“TSK-GEL G2000HXL” produced by Tosoh Corporation+“TSK-GEL G3000HXL” produced by Tosoh Corporation+“TSK-GEL G4000HXL” produced by Tosoh Corporation

Detector: RI (differential refractometer)

Data processing: “GPC workstation EcoSEC-WorkStation” produced by Tosoh Corporation

Measurement Condition:
column temperature 40° C.
developing solvent tetrahydrofuran
flow rate 1.0 ml/min

Standard: in conformity with the measurement manual of “GPC workstation EcoSEC-WorkStation” described above, monodisperse polystyrenes, as described below, having known molecular weights are used

(Polystyrene Used)

“A-500” produced by Tosoh Corporation

“A-1000” produced by Tosoh Corporation

“A-2500” produced by Tosoh Corporation

“A-5000” produced by Tosoh Corporation

“F-1” produced by Tosoh Corporation

“F-2” produced by Tosoh Corporation

“F-4” produced by Tosoh Corporation

“F-10” produced by Tosoh Corporation

“F-20” produced by Tosoh Corporation

“F-40” produced by Tosoh Corporation

“F-80” produced by Tosoh Corporation

“F-128” produced by Tosoh Corporation

Sample: a tetrahydrofuran solution containing 1.0% by mass of resin solid content is filtered by a microfilter (50 μl)

In the chart obtained by the GPC measurement, the peak is split mainly on the basis of molecular weight. However, the present invention is characterized in that the area ratio of the peak that has the maximum area ratio in GPC measurement is 90% or more and preferably 93% or more. When an epoxy resin has such a very narrow molecular weight distribution, the viscosity is low and the content of impurities such as chlorine is reduced. Therefore, the epoxy resin can be suitably used in the electric-electronic field, for example, in semiconductor sealing materials.

In particular, in the case in which catechol and derivatives thereof are used as the raw materials, an epoxy resin included in such a maximum peak may contain, in addition to the compound having a theoretical structure in which n=0 in structural formula (1) above, compounds having a cyclic structure that contains an oxygen atom resulting from two adjacent hydroxy groups and compounds in which one of the hydroxy groups is not converted to glycidyl and remains a hydroxy group since these compounds are not separated under the above-described GPC measurement conditions. It was found that even when compounds having such low molecular weights were contained as secondary components, the physical properties of the cured product were not affected. Therefore, the epoxy resin according to the present invention is not limited to be denoted as an epoxy resin containing only the compound having a theoretical structure in which n=0 in structural formula (1) above.

In the case in which the area ratio of the maximum peak in such GPC measurement is 90% or more and butyl dihydroxybenzene having one butyl group is used as the raw material, the epoxy equivalent is preferably within the range of 190 to 205 g/eq. Setting the epoxy equivalent to be within the above-described range easily ensures appropriate curability and viscosity, favorable handleability, and excellent moisture resistance of a cured product. At this time, the viscosity at 25° C. of epoxy resin (A) is preferably within the range of 400 to 1,000 mPa·s from the viewpoint of more excellent fluidity.

Further, when used for application to electric materials, the total chlorine content in epoxy resin (A) according to the present invention is particularly preferably 2,000 ppm or less and most preferably 1,500 ppm or less.

In this regard, the epoxy equivalent, the viscosity, and the total chlorine content of epoxy resin (A) according to the present invention are measured by the following methods.

Epoxy equivalent: JIS K 7236

Viscosity: JIS K 7233 Single cylinder rotary viscometer method

Total chlorine content: JIS K 7243-3

<Method for Producing Epoxy Resin>

As described above, the method for obtaining epoxy resin (A) according to the present invention requires a refining step of, for example, fractionating a specific compound contained in the maximum peak in the GPC measurement from epoxidized dihydroxybenzene in which an alkyl group having a carbon number of 1 to 8 may be included as a substituent on an aromatic ring.

The dihydroxybenzene in which an alkyl group having a carbon number of 1 to 8 may be included as a substituent on an aromatic ring is the compound as described above, and one type may be used alone or at least two types may be used in combination. Of these, from the viewpoint of a balance between the fluidity of the resulting epoxy resin and the mechanical strength of the cured product, it is preferable that an alkyl group having a more bulky structure be included and hydroxy groups be adjacent to each other. Most preferably, t-butyl catechol is used.

Regarding the method for producing the epoxy resin according to the present invention, as described above, dihydroxybenzene serving as a raw material is reacted with epihalohydrin so as to be epoxidized.

At this time, 1 to 10 mol of epihalohydrin relative to 1 mol of hydroxy groups contained in the raw material is added, and a reaction is performed at a temperature of 20° C. to 120° C. for 0.5 to 10 hours while 0.9 to 2.0 mol of basic catalyst relative to 1 mol of the raw material, butyldihydroxybenzenes, is added in a single operation or is added slowly in the method. The basic catalyst may be a solid, or an aqueous solution thereof may be used. In the case in which the aqueous solution is used, a method in which addition is performed continuously, water and epihalohydrins are continuously distilled from a reaction mixture under reduced pressure or at normal pressure, and separation is further performed so as to remove water and to return epihalohydrins into the reaction mixture continuously may be adopted.

In this regard, when industrial production is performed, all epihalohydrins used for charge in the initial batch of epoxy resin production are fresh. However, in the following and subsequent batches, it is preferable that epihalohydrins recovered from a crude reaction product and new epihalohydrins in an amount corresponding to loss due to consumption during the reaction be used in combination. In this regard, impurities such as glycidol derived from reactions between epihalohydrins and water, organic solvents, and the like may be contained. At this time, there is no particular limitation regarding epihalohydrins used, and examples include epichlorohydrin, epibromohydrin, and β-methylepichlorohydrin. Of these, epichlorohydrin is preferable because of ease in industrial availability.

Meanwhile, specific examples of the basic catalyst include alkaline earth metal hydroxides, alkali metal carbonates, and alkali metal hydroxides. In particular, alkali metal hydroxides are preferable because of excellent catalytic activity in an epoxy resin synthesis reaction, and examples include sodium hydroxide and potassium hydroxide. Regarding usage, these basic catalysts may be used in a state of about 10% by weight to 55% by weight aqueous solution or be used in a state of a solid. In addition, using an organic solvent in combination enables the reaction rate in synthesis of the epoxy resin to be increased. There is no particular limitation regarding such an organic solvent, and examples include ketones, for example, acetone and methyl ethyl ketone, alcohols, for example, methanol, ethanol, 1-propyl alcohol, isopropyl alcohol, 1-butanol, sec-butanol, and tert-butanol, cellosolves, for example, methyl cellosolve and ethyl cellosolve, ethers, for example, tetrahydrofuran, 1,4-dioxane, 1,3-dioxane, and diethoxyethane, and aprotic polar solvents, for example, acetonitrile, dimethyl sulfoxide, and dimethylformamide. These organic solvents may be used alone, or at least two types may be appropriately used in combination so as to adjust polarity.

Subsequently, products of the above-described epoxidation reaction are washed by water, and, thereafter, unreacted epihalohydrins and the organic solvent used in combination are removed by distillation under heating and reduced pressure. Further, to reduce the amount of hydrolyzable halogen in the epoxy resin, the resulting epoxy resin may be dissolved into an organic solvent, for example, toluene, methyl isobutyl ketone, or methyl ethyl ketone, an aqueous solution of an alkali metal hydroxide, for example, sodium hydroxide or potassium hydroxide, may be added, and a reaction may be further performed. At this time, for the purpose of increasing the reaction rate, a phase-transfer catalyst, for example, a quaternary ammonium salt or a crown ether, may be allowed to be present. In the case in which the phase-transfer catalyst is used, the amount of the phase-transfer catalyst used is preferably within the range of 0.1% by mass to 3.0% by mass relative to the epoxy resin used. After the reaction is finished, produced salts are removed by filtration, water washing, or the like. Further, the solvent, for example, toluene or methyl isobutyl ketone, is removed by distillation under heating and reduced pressure so as to obtain an epoxidized product.

The epoxidized product obtained as described above contains high-molecular-weight components and compounds which are not converted to epoxy rings and in which halogen atoms derived from epihalohydrin are bonded. If a certain amount or more of such a component is contained, the fluidity of the epoxy resin is poor. In addition, the curability is impaired, and an adverse effect is exerted in the case of use for application to electric materials. Therefore, it is preferable that a refining step be performed to obtain epoxy resin (A) according to the present invention.

Examples of the refining method include a method in which a compound contained in the maximum peak in the GPC measurement of epoxy resin (A) is fractionated by using a column or the like and a previously known method performed by, for example, combining a method in which an aprotic polar solvent is added to the epoxidized product, a base is added to the resulting solution, and a reaction is performed so as to remove halogen impurities contained in the epoxidized product and a method in which the epoxidized product is dissolved into a solvent, for example, toluene or hexane, and an insoluble portion is separated and removed so as to remove high-molecular-weight components. A more industrially excellent method is a distillation refining method. The distillation refining method is preferable because high-molecular-weight components and secondary components containing a large amount of halogen atoms can be removed in a single operation.

To finally obtain epoxy resin (A) according to the present invention, it is preferable that the content of hydrolyzable chlorine in the epoxidized product before distillation be adjusted to 600 ppm or less, and it is more preferable that various reaction conditions be adjusted so as to ensure 400 ppm or less. However, if the processing condition is excessively severe, secondary reactions, for example, an increase in the molecular weight, are facilitated so as to reduce the yield in the distillation refining step. Therefore, preferably, various reaction conditions are adjusted such that the epoxy equivalent of the epoxidized product is set to be 300 g/eq or less and preferably 250 g/eq or less.

It is also possible to remove by-product salts and the like by a method of filtration, water washing, or the like prior to the distillation refining step. In particular, if an alkali metal hydroxide remains, it is concerned that an increase in molecular weight or gelation is caused. Meanwhile, volatile matters, for example, organic solvents and water, are removed by a method of distillation under reduced pressure or the like.

The distillation refining step is a step of obtaining an epoxy resin with high purity and low viscosity by distilling the epoxidized product obtained as described above so as to remove polymer compounds, inorganic compounds, halogen-atom-containing compounds, and the like. There is no particular limitation regarding the method, and examples include batch distillation using a distillation still, continuous distillation using a rotary evaporator or the like, and thin film molecular distillation of a disc type, a falling film type, or the like. The distillation conditions are different in accordance with the quality of the epoxidized product when the preceding step is finished, the boiling temperatures of impurities to be removed, and the like. Usually, the temperature is 130° C. to 240° C. and preferably 170° C. to 230° C., the retention time is 30 minutes to 5 hours in the case of batch distillation or 0.5 minutes to 10 minutes in the case of continuous distillation, and the pressure is 0.001 Torr to 1 Torr.

<Epoxy Resin Composition>

Epoxy resin (A) according to the present invention may be used in combination with a curing agent. Mixing the curing agent into epoxy resin (A) enables a curable epoxy resin composition to be produced.

Examples of the curing agent usable here include various known epoxy resin curing agents, for example, amine-based compounds, amide-based compounds, acid-anhydride-based compounds, and phenolic compounds.

Specific examples of the amine-based compound include diaminodiphenylmethane, diethylene triamine, triethylene tetramine, diaminodiphenyl sulfone, isophorone diamine, imidazole, a BF₃-amine complex, and a guanidine derivative. Examples of the amide-based compound include dicyandiamide and a polyamide resin synthesized from a linolenic acid dimer and ethylene diamine. Examples of the acid-anhydride-based compound include phthalic anhydride, trimellitic anhydride, pyromellitic anhydride, maleic anhydride, tetrahydrophthalic anhydride, methyl tetrahydrophthalic anhydride, methylnadic anhydride, hexahydrophthalic anhydride, and methyl hexahydrophthalic anhydride. Examples of the phenolic compound include polyvalent-phenolic-hydroxy-containing compounds, for example, a phenol novolak resin, a cresol novolak resin, an aromatic hydrocarbon formaldehyde resin modified phenol resin, a dicyclopentadiene-phenol-addition type resin, a phenol aralkyl resin (Xylok resin), a naphthol aralkyl resin, a triphenylolmethane resin, a tetraphenylolethane resin, a naphthol novolak resin, a naphthol-phenol co-condensation novolak resin, a naphthol-cresol co-condensation novolak resin, a biphenyl-modified phenol resin (polyvalent-phenolic-hydroxy-containing compound in which phenol cores are connected by a bismethylene group), a biphenyl-modified phenol resin (polyvalent naphthol compound in which phenol cores are connected by a bismethylene group), an aminotriazine-modified phenol resin (polyvalent-phenolic-hydroxy-containing compound in which phenol cores are connected by melamine, benzoguanamine, or the like), and an alkoxy-containing aromatic-ring-modified novolak resin (polyvalent-phenolic-hydroxy-containing compound in which phenol cores and alkoxy-containing aromatic rings are connected by formaldehyde).

Further, in the epoxy resin composition according to the present invention, epoxy resin (C) other than epoxy resin (A) specified above may be used in combination within the bounds of not impairing the effect of the present invention.

Examples of epoxy resin (C) include a bisphenol A type epoxy resin, a bisphenol F type epoxy resin, a biphenyl type epoxy resin, a tetramethylbiphenyl type epoxy resin, a polyhydroxynaphthalene type epoxy resin, a phenol novolak type epoxy resin, a cresol novolak type epoxy resin, a triphenylmethane type epoxy resin, a tetraphenylethane type epoxy resin, a dicyclopentadiene-phenol addition reaction type epoxy resin, a phenol aralkyl type epoxy resin, a naphthol novolak type epoxy resin, a naphthol aralkyl type epoxy resin, a naphthol-phenol co-condensation novolak type epoxy resin, a naphthol-cresol co-condensation novolak type epoxy resin, an aromatic hydrocarbon formaldehyde resin modified phenol resin type epoxy resin, a biphenyl-modified novolak type epoxy resin. Of these epoxy resins, it is preferable that a novolak type epoxy resin be used particularly because a cured product having excellent modulus of elasticity at high temperature and mold shrinkage are obtained, it is preferable that a tetramethylbiphenol type epoxy resin, a biphenyl aralkyl type epoxy resin, and a polyhydroxynaphthalene type epoxy resin be used because a cured product having excellent flame retardancy is obtained, and a dicyclopentadiene-phenol addition reaction type epoxy resin is preferable because a cured product having excellent dielectric characteristics is obtained. Meanwhile, in the case in which other epoxy resin (C) is used in combination, it is preferable that 20 to 100 parts by mass of epoxy resin (A) according to the present invention be contained relative to 100 parts by mass of the total of epoxy resin (A) and epoxy resin (C) because the effect of the present invention can be readily realized.

In the epoxy resin composition according to the present invention, regarding the mixing amounts of epoxy resin (A) and the curing agent, from the viewpoint of excellent curability, the total active groups in the curing agent be 0.8 to 1.2 equivalent relative to 1 equivalent of the total epoxy groups in epoxy resin (A) and epoxy resin (C) used in combination as the situation demands.

Meanwhile, the epoxy resin composition may include other thermosetting resins in combination.

Examples of the other thermosetting resin include cyanate ester resins, resins having a benzoxazine structure, maleimide compounds, active ester resins, vinylbenzyl compounds, acrylic compounds, and copolymers of styrene and maleic anhydride. When the above-described other thermosetting resins are used in combination, there is no particular limitation regarding the amount of use provided that the effects of the present invention are not impaired, and the range of 1 to 50 parts by mass in 100 parts by mass of the thermosetting resin composition is preferable.

Examples of the cyanate ester resin include a bisphenol A type cyanate ester resin, a bisphenol F type cyanate ester resin, a bisphenol E type cyanate ester resin, a bisphenol S type cyanate ester resin, a bisphenol sulfide type cyanate ester resin, a phenylene ether type cyanate ester resin, a naphthylene ether type cyanate ester resin, a biphenyl type cyanate ester resin, a tetramethylbiphenyl type cyanate ester resin, a polyhydroxynaphthalene type cyanate ester resin, a phenol novolak type cyanate ester resin, a cresol novolak type cyanate ester resin, a triphenylmethane type cyanate ester resin, a tetraphenylethane type cyanate ester resin, a dicyclopentadiene-phenol addition reaction type cyanate ester resin, a phenol aralkyl type cyanate ester resin, a naphthol novolak type cyanate ester resin, a naphthol aralkyl type cyanate ester resin, a naphthol-phenol co-condensation novolak type cyanate ester resin, a naphthol-cresol co-condensation novolak type cyanate ester resin, an aromatic hydrocarbon formaldehyde resin modified phenol resin type cyanate ester resin, a biphenyl-modified novolak type cyanate ester resin, and an anthracene type cyanate ester resin. These may be used alone, or at least two types may be used in combination.

Of these cyanate ester resins, in particular, a bisphenol A type cyanate ester resin, a bisphenol F type cyanate ester resin, a bisphenol E type cyanate ester resin, a polyhydroxynaphthalene type cyanate ester resin, a naphthylene ether type cyanate ester resin, and a novolak type cyanate ester resin are preferably used because a cured product having excellent heat resistance is obtained. Meanwhile, a dicyclopentadiene-phenol addition reaction type cyanate ester resin is preferable because a cured product having excellent dielectric characteristics is obtained.

There is no particular limitation regarding the resin having a benzoxazine structure, and examples include a reaction product of bisphenol F, formalin, and aniline (F-a type benzoxazine resin) and a reaction product of diaminodiphenylmethane, formalin, and phenol (P-d type benzoxazine resin), a reaction product of bisphenol A, formalin, and aniline, a reaction product of dihydroxydiphenyl ether, formalin, and aniline, a reaction product of diaminodiphenyl ether, formalin, and phenol, a reaction product of dicyclopentadiene-phenol addition type resin, formalin, and aniline, a reaction product of phenolphthalein, formalin, and aniline, and a reaction product of diphenyl sulfide, formalin, and aniline. These may be used alone, or at least two types may be used in combination.

Examples of the maleimide compound include various compounds denoted by any one of structural formulae (i) to (iii) described below.

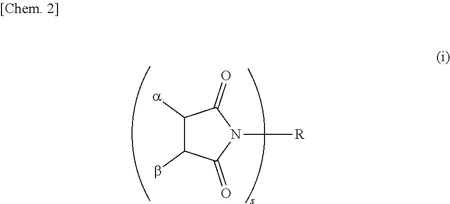

(In the formula, R represents an m-valent organic group, each of α and β represents any one of a hydrogen atom, a halogen atom, an alkyl group, and an aryl group, and s represents an integer of 1 or more.)

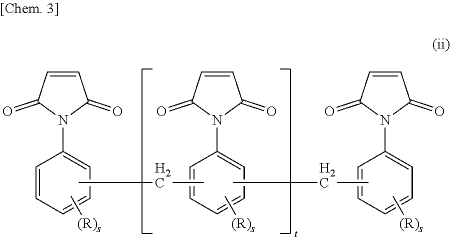

(In the formula, R represents any one of a hydrogen atom, an alkyl group, an aryl group, an aralkyl group, a halogen atom, a hydroxy group, and an alkoxy group, s represents an integer of 1 to 3, and t represents an average of the number of repetitions of the repetition unit and is 0 to 10.)

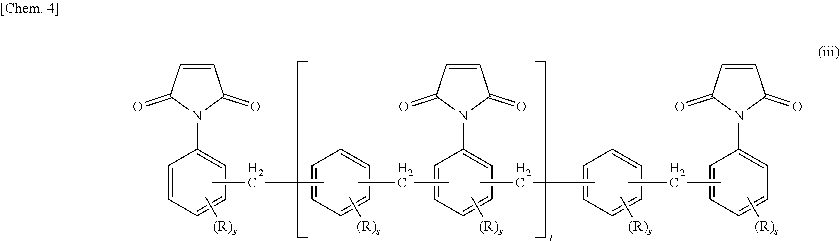

(In the formula, R represents any one of a hydrogen atom, an alkyl group, an aryl group, an aralkyl group, a halogen atom, a hydroxy group, and an alkoxy group, s represents an integer of 1 to 3, and t represents an average of the number of repetitions of the repetition unit and is 0 to 10.) These may be used alone, or at least two types may be used in combination.

There is no particular limitation regarding the active ester resin, and in general, a compound including at least two ester groups having high reaction activity in the molecule, for example, phenol esters, thiophenol esters, N-hydroxyamine esters, and esters of heterocyclic hydroxy compounds, is preferably used. The active ester resin is preferably obtained by a condensation reaction of a carboxylic acid compound and/or a thiocarboxylic acid compound and a hydroxy compound and/or a thiol compound. In particular, from the viewpoint of an improvement of heat resistance, an active ester resin obtained from a carboxylic acid compound or a halide thereof and a hydroxy compound is preferable, and an active ester resin obtained from a carboxylic acid compound or a halide thereof and a phenol compound and/or naphthol compound is more preferable. Examples of the carboxylic acid compound include benzoic acid, acetic acid, succinic acid, maleic acid, itaconic acid, phthalic acid, isophthalic acid, terephthalic acid, and pyromellitic acid and halides thereof. Examples of the phenol compound or naphthol compound include hydroquinone, resorcin, bisphenol A, bisphenol F, bisphenol S, dihydroxydiphenyl ether, phenolphthalein, methylated bisphenol A, methylated bisphenol F, methylated bisphenol S, phenol, o-cresol, m-cresol, p-cresol, catechol, α-naphthol, β-naphthol, 1,5-dihydroxynaphthalene, 1,6-dihydroxynaphthalene, 2,6-dihydroxynaphthalene, dihydroxybenzophenone, trihydroxybenzophenone, tetrahydroxybenzophenone, phloroglucin, benzenetriol, and dicyclopentadiene-phenol addition type resins.

Regarding the active ester resin, specifically, an active-ester-based resin having a dicyclopentadiene-phenol addition structure, an active ester resin having a naphthalene structure, an active ester resin that is acetylated phenol novolak, an active ester resin that is benzoylated phenol novolak, and the like are preferable. Of these, an active ester resin having a dicyclopentadiene-phenol addition structure and an active ester resin having a naphthalene structure are more preferable because an improvement of peel strength is facilitated. More specific examples of the active ester resin having a dicyclopentadiene-phenol addition structure include compounds denoted by general formula (iv) below.

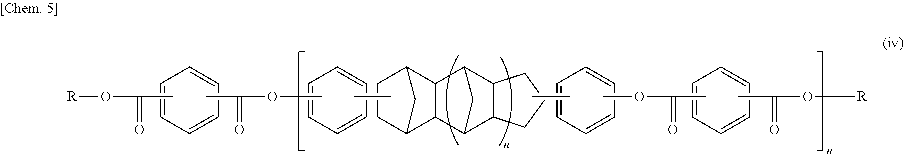

In formula (iv), R represents a phenyl group or a naphthyl group, u represents 0 or 1, and n represents an average of the number of repetitions of the repetition unit and is 0.05 to 2.5. In this regard, from the viewpoint of a reduction in dielectric loss tangent of a cured product of the resin composition and the viewpoint of an improvement of heat resistance, R is preferably a naphthyl group, u is preferably 0, and n is preferably 0.25 to 1.5.

Curing of the epoxy resin composition according to the present invention proceeds even in the case of the epoxy resin composition alone. However, a curing accelerator may be used in combination. Examples of the curing accelerator include tertiary amine compounds, for example, imidazole and dimethylamino pyridine; phosphorus-based compounds, for example, triphenylphosphine; boron trifluoride and a boron trifluoride amine complex such as a boron trifluoride monoethylamine complex; organic acid compounds, for example, thiodipropionic acid; benzoxazine compounds, for example, thiodiphenol benzoxazine and sulfonyl benzoxazine; and sulfonyl compounds. These may be used alone, or at least two types may be used in combination. The amount of the catalyst added is preferably within the range of 0.001 to 15 parts by mass in 100 parts by mass of the epoxy resin composition.

Meanwhile, when the epoxy resin composition according to the present invention is used in an application in which high flame retardancy is required, a non-halogen-based flame retardant containing substantially no halogen atom may be mixed.

Examples of the non-halogen-based flame retardant include a phosphorus-based flame retardant, a nitrogen-based flame retardant, a silicone-based flame retardant, an inorganic flame retardant, and an organometallic-salt-based flame retardant. There is no particular limitation regarding use of these. These may be used alone, a plurality of flame retardants of the same type may be used, or flame retardants of different types may be used in combination.

Regarding the phosphorus-based flame retardant, either the inorganic base or the organic base may be used. Examples of the inorganic compound include red phosphorus, ammonium phosphates, for example, monoammonium phosphate, diammonium phosphate, triammonium phosphate, and polyammonium phosphate, and inorganic nitrogen-containing phosphorus compounds, for example, phosphoric amide.

In this regard, preferably, the red phosphorus is subjected to surface treatment for the purpose of preventing hydrolysis and the like. Examples of the surface treatment method include (i) a method in which covering treatment is performed by using an inorganic compound, for example, magnesium hydroxide, aluminum hydroxide, zinc hydroxide, titanium hydroxide, bismuth oxide, bismuth hydroxide, or bismuth nitrate, or a mixture of these, (ii) a method in which covering treatment is performed by using a mixture of an inorganic compound, for example, magnesium hydroxide, aluminum hydroxide, zinc hydroxide, or titanium hydroxide, and a thermosetting resin, for example, a phenol resin, and (iii) a method in which covering treatment is doubly performed by using a thermosetting resin, for example, a phenol resin, on a coating of an inorganic compound, for example, magnesium hydroxide, aluminum hydroxide, zinc hydroxide, or titanium hydroxide.

Examples of the organophosphorus-based compound include general-purpose organophosphorus-based compounds, for example, a phosphoric acid ester compound, a phosphonic acid compound, a phosphinic acid compound, a phosphine oxide compound, a phosphorane compound, and an organic nitrogen-containing phosphorus compound and, in addition, cyclic organophosphorus compounds, for example, 9,10-dihydro-9-oxa-10-phosphaphenanthrene-10-oxide, 10-(2,5-dihydroxyphenyl)-10H-9-oxa-10-phosphaphenanthrene-10-oxide, and 10-(2,7-dihydroxynaphthyl)-10H-9-oxa-10-phosphaphenanthrene-10-oxide, and derivatives produced by reacting the cyclic organophosphorus compound with a compound, for example, an epoxy resin or phenol resin.

The amount of the phosphorus-based flame retardant mixed is appropriately selected in accordance with the type of the phosphorus-based flame retardant, other components of the resin composition, and the degree of predetermined flame retardancy. For example, when red phosphorus is used as the non-halogen-based flame retardant, the amount of mixing is preferably within the range of 0.1 parts by mass to 2.0 parts by mass in 100 parts by mass of the resin composition in which all the non-halogen-based flame retardant and others, for example, fillers and additives, are mixed. Likewise, when the organophosphorus compound is used, the amount of mixing is preferably within the range of 0.1 parts by mass to 10.0 parts by mass, and the amount of mixing is more preferably within the range of 0.5 parts by mass to 6.0 parts by mass.

Meanwhile, when the phosphorus-based flame retardant is used, hydrotalcite, magnesium hydroxide, a boron compound, zirconium oxide, black dye, calcium carbonate, zeolite, zinc molybdate, activated carbon, and the like may be used in combination with the phosphorus-based flame retardant.

Examples of the nitrogen-based flame retardant include a triazine compound, a cyanuric acid compound, an isocyanuric acid compound, and phenothiazine, and a triazine compound, a cyanuric acid compound, and an isocyanuric acid compound are preferable.

Examples of the triazine compound include melamine, acetoguanamine, benzoguanamine, mellon, melam, succinoguanamine, ethylene dimelamine, melamine polyphosphate, and triguanamine. In addition, examples include (1) aminotriazine sulfate compounds, for example, guanylmelamine sulfate, melem sulfate, and melam sulfate, (2) co-condensates of phenols, for example, phenol, cresol, xylenol, butylphenol, and nonylphenol, melamines, for example, melamine, benzoguanamine, acetoguanamine, and formguanamine, and formaldehyde, (3) mixtures of the co-condensates described in (2) and phenol resins, for example, phenol-formaldehyde condensates, and (4) compounds produced by further modifying those described in (2) or (3) with tung oil, isomerized linseed oil, or the like.

Examples of the cyanuric acid compound include cyanuric acid and melamine cyanurate.

The amount of the nitrogen-based flame retardant mixed is appropriately selected in accordance with the type of the nitrogen-based flame retardant, other components of the resin composition, and the degree of predetermined flame retardancy. For example, the amount of mixing is preferably within the range of 0.05 to 10 parts by mass in 100 parts by mass of the resin composition in which all the non-halogen-based flame retardant and others, for example, fillers and additives, are mixed, and the amount of mixing is more preferably within the range of 0.1 parts by mass to 5 parts by mass.

Meanwhile, when the nitrogen-based flame retardant is used, a metal hydroxide, a molybdenum compound, or the like may be used in combination.

There is no particular limitation regarding the compound used as the silicone-based flame retardant provided that the compound is an organic compound containing silicon atoms. Examples of the silicone-based flame retardant include a silicone oil, a silicone rubber, and a silicone resin. The amount of the silicone-based flame retardant mixed is appropriately selected in accordance with the type of the silicone-based flame retardant, other components of the resin composition, and the degree of predetermined flame retardancy. For example, the amount of mixing is preferably within the range of 0.05 to 20 parts by mass in 100 parts by mass of the resin composition in which all the non-halogen-based flame retardant and others, for example, fillers and additives, are mixed. Meanwhile, when the silicone-based flame retardant is used, a molybdenum compound, alumina, or the like may be used in combination.

Examples of the inorganic flame retardant include a metal hydroxide, a metal oxide, a metal carbonate compound, a metal powder, a boron compound, and low-melting-temperature glass.

Examples of the metal hydroxide include aluminum hydroxide, magnesium hydroxide, dolomite, hydrotalcite, calcium hydroxide, barium hydroxide, and zirconium hydroxide.

Examples of the metal oxide include zinc molybdate, molybdenum trioxide, zinc stannate, tin oxide, aluminum oxide, iron oxide, titanium oxide, manganese oxide, zirconium oxide, zinc oxide, molybdenum oxide, cobalt oxide, bismuth oxide, chromium oxide, nickel oxide, copper oxide, and tungsten oxide.

Examples of the metal carbonate compound include zinc carbonate, magnesium carbonate, calcium carbonate, barium carbonate, basic magnesium carbonate, aluminum carbonate, iron carbonate, cobalt carbonate, and titanium carbonate.

Examples of the metal powder include aluminum, iron, titanium, manganese, zinc, molybdenum, cobalt, bismuth, chromium, nickel, copper, tungsten, and tin.

Examples of the boron compound include zinc borate, zinc metaborate, barium metaborate, boric acid, and borax.

Examples of the low-melting-temperature glass include CEEPREE (Bokusui Brown Co., Ltd.), hydrated glass SiO₂—MgO—H₂O, and vitreous compounds based on, for example, PbO—B₂O₃, ZnO—P₂O₅—MgO, P₂O₅—B₂O₃—PbO—MgO, P—Sn—O—F, PbO—V₂O₅—TeO₂, Al₂O₃—H₂O, and lead borosilicate.

The amount of the inorganic flame retardant mixed is appropriately selected in accordance with the type of the inorganic flame retardant, other components of the resin composition, and the degree of predetermined flame retardancy. For example, the amount of mixing is preferably within the range of 0.05 parts by mass to 20 parts by mass in 100 parts by mass of the resin composition in which all the non-halogen-based flame retardant and others, for example, fillers and additives, are mixed, and the amount of mixing is more preferably within the range of 0.5 parts by mass to 15 parts by mass.

Examples of the organometallic-salt-based flame retardant include ferrocene, an acetylacetonate metal complex, an organometallic carbonyl compound, an organic cobalt salt compound, an organic sulfonic acid metal salt, and a compound in which a metal atom and an aromatic compound or a heterocyclic compound are ion-bonded or coordinate-bonded to each other.

The amount of the organometallic-salt-based flame retardant mixed is appropriately selected in accordance with the type of the organometallic-salt-based flame retardant, other components of the resin composition, and the degree of predetermined flame retardancy. For example, the amount of mixing is preferably within the range of 0.005 parts by mass to 10 parts by mass in 100 parts by mass of the resin composition in which all the non-halogen-based flame retardant and others, for example, fillers and additives, are mixed.

The epoxy resin composition according to the present invention may include an inorganic filler, as the situation demands. Examples of the inorganic filler include fused silica, crystalline silica, alumina, silicon nitride, and aluminum hydroxide. When the amount of the inorganic filler mixed is particularly increased, it is preferable that fused silica be used. The fused silica that is either crushed or spherical may be used, and for the purpose of increasing the amount of the fused silica mixed and suppressing an increase in melt viscosity of a molding material, it is preferable that spherical fused silica be mainly used. Further, to increase the amount of the spherical silica mixed, it is preferable that the particle size distribution of the spherical silica be appropriately adjusted. The filling factor is preferably high in consideration of the flame retardancy and is particularly preferably 20% by mass or more relative to the total mass of the epoxy resin composition. Meanwhile, in the use for application to a conductive paste or the like, a conductive filler, for example, a silver powder or a copper powder, may be used.

The epoxy resin composition according to the present invention may further include various additives, for example, a silane coupling agent, a mold release agent, a pigment, and an emulsifier, as the situation demands.

<Use of Epoxy Resin Composition>

The epoxy resin composition according to the present invention may be applied to a semiconductor sealing material, a semiconductor device, a prepreg, a printed circuit board, a build-up substrate, a build-up film, a fiber-reinforced composite material, a fiber-reinforced resin molded article, a conductive paste, and the like.

1. Semiconductor Sealing Material

A method for obtaining a semiconductor sealing material from the epoxy resin composition according to the present invention may be a method in which the epoxy resin composition, the curing accelerator, and additives, for example, an inorganic filler, are sufficiently melt-mixed so as to be homogenized by using an extruder, a kneader, a roll, or the like, as the situation demands. In this regard, fused silica is usually used as the inorganic filler. In the case of use as a high-thermal-conductivity semiconductor sealing material for a power transistor or power IC, crystalline silica having higher thermal conductivity than the fused silica, alumina, silicon nitride, or the like may be used at a high filling factor, or fused silica, crystalline silica, alumina, silicon nitride, or the like may be used. The filling factor of the inorganic filler is preferably within the range of 30% by mass to 95% by mass relative to 100 parts by mass of the epoxy resin composition. In particular, for the purpose of improving the flame retardancy, the moisture resistance, and the solder crack resistance and decreasing a linear expansion coefficient, 70 parts by mass or more is preferable, and 80 parts by mass or more is further preferable.

2. Semiconductor Device

A method for obtaining a semiconductor device from the epoxy resin composition according to the present invention may be a method in which the semiconductor sealing material is cast or molded by using a transfer molding machine, an injection molding machine, or the like and is further heated at 50° C. to 200° C. for 2 to 10 hours.

3. Prepreg

A method for obtaining a prepreg from the epoxy resin composition according to the present invention may be a method in which the prepreg is obtained by impregnating a reinforcing base material (paper, glass cloth, glass nonwoven fabric, aramid paper, aramid cloth, glass mat, glass roving cloth, or the like) with the curable resin composition made into varnish by being mixed with an organic solvent and, thereafter, performing heating at a heating temperature in accordance with the type of the solvent used, preferably at 50° C. to 170° C. There is no particular limitation regarding the mass ratios of the resin composition to the reinforcing base material used at this time, and it is usually preferable to adjust such that the resin content in the prepreg falls into 20% by mass to 60% by mass.

Examples of the organic solvent used here include methyl ethyl ketone, acetone, dimethylformamide, methyl isobutyl ketone, methoxypropanol, cyclohexanone, methylcellosolve, ethyl diglycol acetate, and propylene glycol monomethyl ether acetate. Selection and the optimum amount of use may be appropriately determined in accordance with the use. For example, when a printed circuit board is further produced from the prepreg, as described below, a polar solvent such as methyl ethyl ketone, acetone, or dimethylformamide having a boiling temperature of 160° C. or lower is preferably used, and the polar solvent is used preferably at such a proportion that a non-volatile content becomes 40% by mass to 80% by mass.

4. Printed Circuit Board

A method for obtaining a printed circuit board from the epoxy resin composition according to the present invention may be a method in which the prepregs are stacked by a common process, copper foil is appropriately stacked, and thermocompression bonding is performed under pressure of 1 to 10 MPa at 170° C. to 300° C. for 10 minutes to 3 hours.

5. Build-Up Substrate

A method for obtaining a build-up substrate from the epoxy resin composition according to the present invention may be a method including steps 1 to 3. In step 1, initially a circuit board provided with circuits is coated with the curable resin composition, into which rubber, filler, and the like are appropriately mixed, by using a spray coating method, a curtain coating method, or the like and, thereafter, curing is performed. In step 2, as the situation demands, predetermined through hole portions and the like are bored in the circuit board coated with the epoxy resin composition, treatment with a roughening agent is performed, the surface is washed with hot water so as to form unevenness on the substrate, and plating treatment with a metal, for example, copper, is performed. In step 3, as the situation demands, the operations of steps 1 and 2 are successively repeated so as to form a build-up substrate by alternately building up resin insulating layers and conductive layers provided with predetermined circuit patterns. In this regard, in the above-described step, boring of the through hole portions is preferably performed after formation of the outermost layer that is the resin insulating layer. Alternatively, regarding the build-up substrate according to the present invention, copper foil with a resin in which the resin composition is semi-cured on the copper foil may be thermocompression bonded at 170° C. to 300° C. to a wiring board provided with the circuits so as to form a roughened surface and to produce a build-up substrate without the step of performing plating treatment.

6. Build-Up Film

A method for obtaining a build-up film from the epoxy resin composition according to the present invention may be a method in which, for example, a support film is coated with the curable resin composition and, thereafter, drying is performed so as to form a resin composition layer on the support film. When the epoxy resin composition according to the present invention is used for the build-up film, it is important that the film is softened under the temperature condition (usually 70° C. to 140° C.) of lamination based on a vacuum lamination method and exhibits fluidity (resin flowing) so as to enable the via holes or through holes formed in the circuit boards to be filled with the resin at the same time with lamination of the circuit boards. It is preferable that the above-described components be mixed so as to realize such characteristics.

In this regard, the diameter of the through hole in the circuit board is usually 0.1 to 0.5 mm, and the depth is usually 0.1 to 1.2 mm. It is usually preferable that filling with the resin can be performed in this range. Meanwhile, when both surfaces of the circuit board are subjected to lamination, it is desirable that about half the through hole be filled.

A specific method for obtaining a build-up film may be a method in which, after an epoxy resin composition is prepared by being made into a varnish by mixing with an organic solvent, the surface of a support film (Y) is coated with the above-described composition, and the organic solvent is dried by further performing heating, hot air blowing, or the like so as to form a layer (X) of the epoxy resin composition.

Regarding the organic solvent used here, ketones, for example, acetone, methyl ethyl ketone, and cyclohexanone, acetic acid esters, for example, ethyl acetate, butyl acetate, cellosolve acetate, propylene glycol monomethyl ether acetate, and carbitol acetate, carbitols, for example, cellosolve and butyl carbitol, aromatic hydrocarbons, for example, toluene and xylene, dimethylformamide, dimethylacetamide, N-methylpyrrolidone, and the like are preferably used, and the organic solvent is preferably used at such a proportion that a non-volatile content becomes 30% by mass to 60% by mass.

Meanwhile, the thickness of the layer (X) of the resulting resin composition has to be usually more than or equal to the thickness of the conductive layer. The thickness of the conductive layer included in the circuit board is usually within the range of 5 to 70 μm and, therefore, the resin composition layer has a thickness of preferably 10 to 100 μm. In this regard, the layer (X) of the resin composition according to the present invention may be protected by a protective film described later. Protection by the protective film can prevent adhesion of dust and the like to the resin composition layer surface and occurrence of flaws.

Examples of the support film or the protective film include polyolefins, for example, a polyethylene, a polypropylene, and a polyvinyl chloride, polyesters, for example, a polyethylene terephthalate (hereafter may also be referred to as “PET”) and a polyethylene naphthalate, a polycarbonate, a polyimide, and, in addition, release paper and metal foil, for example, copper foil and aluminum foil. In this regard, the support film and the protective film may be subjected to mud treatment, corona treatment, and, in addition, release treatment. There is no particular limitation regarding the thickness of the support film, and the thickness is usually 10 to 150 μm and preferably within the range of 25 to 50 μm. Meanwhile, the thickness of the protective film is preferably 1 to 40 μm.

The support film (Y) is peeled after the circuit board is subjected to lamination or the insulating layer is formed by heat curing. When the support film (Y) is peeled after the epoxy resin composition layer constituting the build-up film is heat-cured, adhesion of dust and the like during the curing step can be prevented. In the case in which peeling is performed after curing, the support film is usually subjected to release treatment in advance.

Meanwhile, a multilayer printed circuit board can be produced from the build-up film obtained as described above. For example, in the case in which the layers (X) of the resin composition are protected by the protective films, these are peeled and, thereafter, the layer (X) of the resin composition is laminated on one surface or both surfaces of the circuit board so as to come into direct contact with the circuit board by, for example, a vacuum lamination method. The method of lamination may be a batch type or continuous type by using a roll. In this regard, as the situation demands, the build-up film and the circuit board may be heated before lamination is performed (preheat). Regarding the conditions for the lamination, the pressure bonding temperature (lamination temperature) is set to be preferably 70° C. to 140° C., the pressure of the pressure bonding is set to be preferably 1 to 11 kgf/cm² (9.8×10⁴ to 107.9×10⁴ N/m²), and lamination is performed preferably under reduced pressure at an air pressure of 20 mm Hg (26.7 hPa) or less.

7. Fiber-Reinforced Composite Material

A method for obtaining a fiber-reinforced composite material (sheet like intermediate material in which reinforcing fiber is impregnated with a resin) from the epoxy resin composition according to the present invention may be a production method in which a varnish is prepared by homogeneously mixing components constituting the epoxy resin composition, a reinforcing base material composed of the reinforcing fiber is impregnated with the varnish and, thereafter, a polymerization reaction is performed.

Specifically, the curing temperature when such a polymerization reaction is performed is preferably within the range of 50° C. to 250° C. In particular, it is preferable that curing be performed at 50° C. to 100° C. so as to produce a tuck-free cured product and, thereafter, treatment under the temperature condition of 120° C. to 200° C. be further performed.

In this regard, the reinforcing fiber may be any one of twisted yarn, untwisted yarn, zero twist yarn, and the like, and untwisted yarn and zero twist yarn are preferable because compatibility between the moldability of a fiber-reinforced plastic member and the mechanical strength is ensured. Further, regarding the form of the reinforcing fiber, fiber directions may be equalized to one direction, or a textile may be used. The textile may be freely selected among plain weave, satin weave, and the like in accordance with a serve area or the use. Specific examples include carbon fiber, glass fiber, aramid fiber, boron fiber, alumina fiber, and silicon carbide fiber because of excellent mechanical strength and durability. At least two types of these may be used in combination. Of these, carbon fiber is preferable because of particularly good strength of a molded article. Carbon fiber of various types, for example, a polyacrylonitrile type, a pitch type, and a rayon type, may be used. In particular, the polyacrylonitrile type is preferable because high-strength carbon fiber is readily obtained. In this regard, when a fiber-reinforced composite material is produced by impregnating a reinforcing base material composed of the reinforcing fiber with the varnish, the amount of the reinforcing fiber used is preferably an amount corresponding to the volume content of the reinforcing fiber within the range of 40% to 85% in the fiber-reinforced composite material.

8. Fiber-Reinforced Resin Molded Article

A method for obtaining a fiber-reinforced molded article (molded article produced by curing a sheet like member in which the reinforcing fiber is impregnated with a resin) from the epoxy resin composition according to the present invention may be a method in which a prepreg is produced by impregnating the reinforcing fiber with the varnish by, for example, a hand lay-up method or spray-up method including laying fiber aggregate in a mold and stacking multiple layers of the varnish; a vacuum bag method including using any one of a male die or a female die, stacking base materials composed of the reinforcing fiber while impregnating the base materials with the varnish and performing molding, performing covering with a flexible die that can apply a pressure to a material to be molded, and performing hermetic sealing and vacuum (reduced pressure) molding; an SMC press method including compression molding, in a mold, a reinforcing-fiber-containing varnish made into a sheet in advance; or an RTM method including injecting the varnish into a combination die with fiber laid therein, and by baking the prepreg in a large autoclave. In this regard, the fiber-reinforced resin molded article obtained as described above is a molded article including the reinforcing fiber and the cured product of the epoxy resin composition. Specifically, the amount of the reinforcing fiber in the fiber-reinforced molded article is preferably within the range of 40% by mass to 70% by mass and particularly preferably within the range of 50% by mass to 70% by mass from the viewpoint of the strength.

9. Conductive Paste

A method for obtaining a conductive paste from the epoxy resin composition according to the present invention is, for example, a method in which fine conductive particles are dispersed into the curable resin composition. The conductive paste can be made into a circuit connection paste resin composition or an anisotropic conductive adhesive in accordance with the type of fine conductive particles used.

### EXAMPLES

Next, the present invention will be specifically described with reference to the examples and the comparative examples. Hereafter “part” or “%” is on a mass basis, unless otherwise specified.

### Synthesis Example 1: Synthesis of Polycondensate of 4-Tert-Butylcatechol and Epichlorohydrin

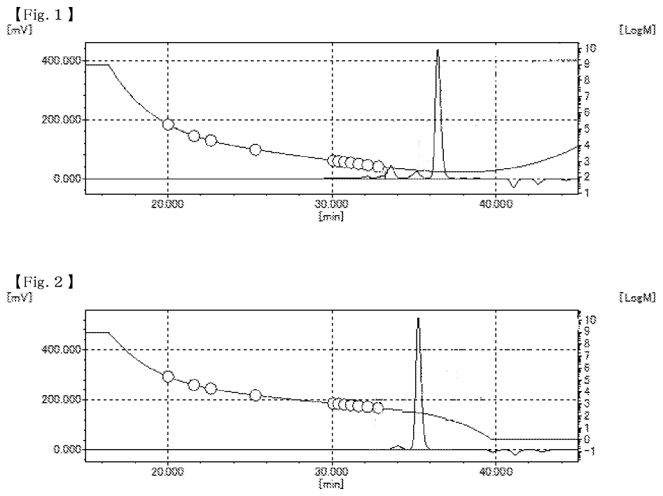

After charging 200 g of 4-t-butylcatechol, 892 g of epichlorohydrin, and 268 g of isopropyl alcohol into a 2-liter separable flask that was provided with a thermometer, a dropping funnel, a cooling tube, an agitator, and a baffle plate and that had a separating cock at the lower portion, agitation, dissolution, and heating to 40° C. were performed. Subsequently, 554 g of 20% aqueous solution of sodium hydroxide was dropped over 3 hours from the dropping funnel. After the dropping was finished, agitation was continued for 30 minutes so as to complete the reaction. Thereafter, agitation was stopped, still standing was performed, and the saline solution as the lower layer was separated and removed. Next, excess epichlorohydrin, isopropyl alcohol, and water were recovered by distillation. The resulting crude resin was dissolved into 503 g of toluene, 50 g of 5% aqueous solution of sodium hydroxide was added, and agitation was performed at 80° C. for 3 hours. Subsequently, the resulting salts and alkalis were subjected to oil-water separation by water washing so as to be removed. Dehydration and filtration were performed, and toluene was recovered by distillation so as to obtain epoxy resin (A′-1). FIG. 1 shows the chart obtained by GPC measurement of the resulting epoxy resin (A′-1). The area ratio of the maximum peak based on the GPC measurement was 80%.

In this regard, the GPC measurement was performed by the following method.

### <GPC Measurement Conditions>

Measurement apparatus: “HLC-8320 GPC” produced by Tosoh Corporation

Column: guard column “HXL-L” produced by Tosoh Corporation+“TSK-GEL G2000HXL” produced by Tosoh Corporation+“TSK-GEL G2000HXL” produced by Tosoh Corporation+“TSK-GEL G3000HXL” produced by Tosoh Corporation+“TSK-GEL G4000HXL” produced by Tosoh Corporation

Detector: RI (differential refractometer)

Data processing: “GPC workstation EcoSEC-WorkStation” produced by Tosoh Corporation

Measurement Condition:
column temperature 40° C.
developing solvent tetrahydrofuran
flow rate 1.0 ml/min

Standard: in conformity with the measurement manual of “GPC workstation EcoSEC-WorkStation” described above, monodisperse polystyrenes, as described below, having known molecular weights were used

(Polystyrene Used)

“A-500” produced by Tosoh Corporation

“A-1000” produced by Tosoh Corporation

“A-2500” produced by Tosoh Corporation

“A-5000” produced by Tosoh Corporation

“F-1” produced by Tosoh Corporation

“F-2” produced by Tosoh Corporation

“F-4” produced by Tosoh Corporation

“F-10” produced by Tosoh Corporation

“F-20” produced by Tosoh Corporation

“F-40” produced by Tosoh Corporation

“F-80” produced by Tosoh Corporation

“F-128” produced by Tosoh Corporation

Sample: a tetrahydrofuran solution containing 1.0% by mass of resin solid content was filtered by a microfilter (50 μl)

### Example 1

Epoxy resin (A′-1) obtained in synthesis example 1 was processed by using a falling-film molecular distillation apparatus (produced by SIBATA SCIENTIFIC TECHNOLOGY LTD.) with a heat transfer area of about 0.03 m² at a degree of vacuum of 2 to 20 Pa, a liquid feed rate of 100 ml/h, and an evaporation surface temperature of 220° C. to 250° C. so as to obtain epoxy resin (A-1) as a distilled fraction with a yield of 71%. FIG. 2 shows the chart obtained by GPC measurement of epoxy resin (A-1). The area ratio of the maximum peak based on the GPC measurement was 95%.

### Example 2

Epoxy resin (A′-1) obtained in synthesis example 1 was processed by using a falling-film molecular distillation apparatus (produced by SIBATA SCIENTIFIC TECHNOLOGY LTD.) with a heat transfer area of about 0.03 m² at a degree of vacuum of 2 to 20 Pa, a liquid feed rate of 100 ml/h, and an evaporation surface temperature of 180° C. to 210° C. so as to obtain epoxy resin (A-2) as a distilled fraction with a yield of 57%. The area ratio of the maximum peak based on the GPC measurement of epoxy resin (A-2) was 96%.

### Example 3

Epoxy resin (A′-1) obtained in synthesis example 1 was processed by using a falling-film molecular distillation apparatus (produced by SIBATA SCIENTIFIC TECHNOLOGY LTD.) with a heat transfer area of about 0.03 m² at a degree of vacuum of 2 to 20 Pa, a liquid feed rate of 100 ml/h, and an evaporation surface temperature of 140° C. to 170° C. so as to obtain epoxy resin (A-3) as a distilled fraction with a yield of 48%. The area ratio of the maximum peak based on the GPC measurement of epoxy resin (A-3) was 97%.

Epoxy resin (A′-2) used for comparison was bisphenol A type liquid epoxy resin EPICLON 850-S (produced by DIC Corporation), and epoxy resin (A′-3) was bisphenol F type liquid epoxy resin EPICLON 830-S (produced by DIC Corporation).

The physical property values of the epoxy resins obtained in examples 1 to 3 and the epoxy resin used in the comparative example are shown in Table 1.

TABLE 1

| | | | | Comparative | Comparative | Comparative |
|---|---|---|---|---|---|---|
| | Example 1 | Example 2 | Example 3 | example 1 | example 2 | example 3 |
| Epoxy resin | (A-1) | (A-2) | (A-3) | (A′-1) | (A′-2) | (A′-3) |
| Epoxy equivalent (g/eq.) | 202 | 199 | 197 | 210 | 188 | 169 |
| Viscosity (mPa · s) | 620 | 530 | 490 | 1260 | 13100 | 3510 |
| Total chlorine (ppm) | 1320 | 1190 | 1120 | 2100 | 1500 | 1430 |

<Method for Producing Cured Product>

A resin composition in which an epoxy resin, a curing agent (Me-THPA: methyltetrahydrophthalic acid anhydride), and a curing accelerator were mixed and deaerated was injected between two glass plates each having a thickness of 2 mm and each being coated with a mold release agent, heating was performed at 80° C. for 1 hour, and, thereafter heating was performed at 110° C. for 4 hours so as to produce a cured product.

<Method for Measuring Gel Time>

The gel time was measured by heating 1 ml of resin composition, which was subjected to mixing and deaeration at 25° C., on a hot plate heated to 150° C.

<Method for Measuring Moisture Absorptivity>

The cured product was cut into a test piece having the size of 25 mm in thickness and 75 mm in length. The test piece was left to stand for 4 hours in an atmosphere of 121° C./100% RH by using HAST CHAMBER (produced by HIRAYAMA Manufacturing Corporation), and the weight change between before and after the processing was measured.

<Method for Measuring Mechanical Strength>

The cured product was cut into a test piece having the size of 10 mm in thickness and 80 mm in length, and the bending strength and the bending modulus of elasticity at room temperature were determined by using a universal testing machine (AGI produced by SHIMADZU CORPORATION). In this regard, the measurement was performed at n=3, and an average value was used. Each of the film thickness and the width of the test piece was measured at five points, and the average value was used as the calculation value.

TABLE 2

| | | | | | Comparative | Comparative | Comparative |
|---|---|---|---|---|---|---|---|
| Mixing | | Example 4 | Example 5 | Example 6 | example 4 | example 5 | example 6 |
| Epoxy resin | (A-1) | 110 | | | | | |
| | (A-2) | | 109 | | | | |
| | (A-3) | | | 109 | | | |
| | (A′-1) | | | | 112 | | |
| | (A′-2) | | | | | 105 | |
| | (A′-3) | | | | | | 98 |
| Curing agent | Me-THPA | 90 | 91 | 91 | 88 | 94 | 102 |
| Curing accelerator | 1,2-dimethyl imidazole | 2 | 2 | 2 | 2 | 2 | 2 |

| Measurement result | | | | | | |
|---|---|---|---|---|---|---|
| Gel time 150° C. (sec) | 36 | 35 | 35 | 38 | 52 | 58 |
| Moisture absorptivity PCT-4 hr (%) | 2.1 | 2.0 | 2.0 | 2.4 | 2.9 | 3.1 |
| Bending strength (kg/mm²) | 14.9 | 15.1 | 15.3 | 14.7 | 14.4 | 13.8 |
| Bending modulus of elasticity (kg/mm²) | 435 | 438 | 440 | 368 | 323 | 315 |

1. An epoxy resin that is an epoxy resin (A) primarily containing an epoxy resin denoted by a structural formula (1) below, 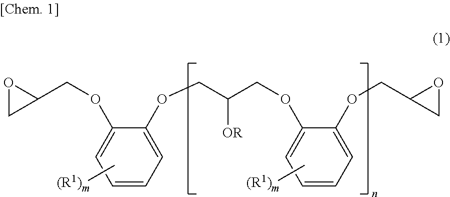
[in the structural formula (1), R¹ represents a butyl group, R represents a hydrogen atom or a glycidyl group, m represents 1, n represents the number of repetitions and has an average value of 0.01 to 5, and R may be the same or different in each repetition]
wherein the area ratio of the maximum peak in GPC measurement is 90% or more.

2. (canceled)

3. The epoxy resin according to claim 1, wherein the total chlorine content in the epoxy resin (A) is 2,000 ppm or less.

4. The epoxy resin according to claim 1, wherein the epoxy equivalent is within the range of 190 to 205 g/eq.

5. (canceled)

6. The epoxy resin according to claim 1, wherein the viscosity at 25° C. of the epoxy resin (A) is within the range of 400 to 1,000 mPa·s.

7. The epoxy resin according to claim 1, wherein the butyl group is a t-butyl group.

8. An epoxy resin composition comprising the epoxy resin according to claim 1 and a curing agent as indispensable components.

9. A cured product of the epoxy resin composition according to claim 8.

10-17. (canceled)

18. An epoxy resin composition comprising the epoxy resin according to claim 3 and a curing agent as indispensable components.

19. An epoxy resin composition comprising the epoxy resin according to claim 4 and a curing agent as indispensable components.

20. An epoxy resin composition comprising the epoxy resin according to claim 6 and a curing agent as indispensable components.

21. An epoxy resin composition comprising the epoxy resin according to claim 7 and a curing agent as indispensable components.

22. A cured product of the epoxy resin composition according to claim 18.

23. A cured product of the epoxy resin composition according to claim 19.

24. A cured product of the epoxy resin composition according to claim 20.

25. A cured product of the epoxy resin composition according to claim 21.
